(19) United States
(12) Patent Application Publication
(10) Pub. No.: US 2026/0111757 A1
(43) Pub. Date: Apr. 23, 2026

(54) HARDWARE-BASED PROBLEM DECOMPOSITION

(71) Applicant: Dell Products L.P., Round Rock, TX (US)

(72) Inventors: Miguel Paredes Quiñones, Campinas (BR); Diego Vrague Noble, Pelotas (BR); Ítalo Gomes Santana, Rio de Janeiro (BR); Robert A. Lincourt, Franklin, MA (US)

(21) Appl. No.: 18/917,077

(22) Filed: Oct. 16, 2024

(51) Int. Cl. G06N 5/01

(52) U.S. Cl. CPC G06N 5/01

(57) ABSTRACT

Decomposing problems such as quadratic unconstrained binary optimization problems is disclosed. A problem is decomposed into subproblems and the subproblems are classified into a first set of subproblems for classical annealers and a second set of subproblems for quantum annealers. The sets are processed to move subproblems from the second set to the first set. This is achieved by exchanging qubits among the subproblems and then reclassifying the modified subproblems. Moving subproblems from the second set to the first set reduces the need for quantum annealers. The subproblems in the two sets are executed and a solution to the original problem is determined from the solutions to the subproblems.

### TECHNOLOGICAL FIELD OF THE DISCLOSURE

Embodiments disclosed herein generally relate to problems including Quadradic Unconstrained Binary Optimization (QUBO) problems. More particularly, at least some embodiments relate to systems, hardware, software, computer-readable media, and methods for decomposing or cutting QUBOs into smaller QUBOs, reconfiguring the smaller QUBOs, solving the smaller QUBOs, and/or generating solutions to the original QUBOs from the solutions of the corresponding smaller QUBOs.

### BACKGROUND

QUBO decomposition, or QUBO cutting, is a technique that enables large QUBO problems to be solved by simulated (emulated) annealers or quantum annealers. Generally, QUBO decomposition is a technique that splits an original QUBO problem into a series of smaller QUBO problems (subQUBO problems). One reason for decomposing a QUBO is that annealers available to solve the original QUBO may not have enough qubits. Smaller QUBO problems, on the other hand, fit into limited-qubit annealers. Further, when orchestrating the process of solving smaller QUBO problems, the smaller QUBO problems can be distributed to or orchestrated on multiple quantum annealers and/or classical annealers.

More generally, QUBOs are difficult to solve and some QUBOs are harder to solve than others. For instance, when the eigenvalues of a QUBO matrix are indefinite and when the eigenvalues are close in absolute value, the QUBO can be treated as hard-to-solve by a classical annealer. This is because these features define a very irregular and rugged optimization landscape on the energy function. A quantum annealer, in contrast, provides an advantage in solving hard problems because quantum tunneling effects are leveraged in quantum annealing hardware to handle irregular landscapes simultaneously.

Unfortunately, using quantum annealers implies high costs that may not be affordable in some use cases, especially considering expenses in accessing quantum annealers as well as the availability of this kind of specialized hardware. Alternatively, simulated quantum annealers, which are emulated in classical computing systems, are feasible options due in part to the lower cost.

Another concern associated with solving QUBOs is the difficulty in attaining or meeting service level objectives. When solving QUBOs, the difficulty in complying with or satisfying service level objectives becomes more complicated when the process of solving a QUBO also requires the QUBO to be decomposed or cut into smaller QUBOs.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of solving a problem such as a quadratic unconstrained binary optimization problem;

FIG. 2 discloses additional aspect of solving a problem such as a quadratic unconstrained binary optimization problem;

FIG. 3 discloses yet further aspects of solving a problem such as quadratic unconstrained binary optimization problem; and

FIG. 4 discloses aspects of a computing device, system, or entity.

### DETAILED DESCRIPTION OF SOME EXAMPLE EMBODIMENTS

Embodiments disclosed herein generally relate to Quadratic Unconstrained Binary Optimization (QUBO) problems and to solving QUBO problems. More particularly, at least some embodiments relate to systems, hardware, software, computer-readable media, and methods for decomposing QUBOs into smaller QUBOs and orchestrating the process of solving the smaller QUBOs on a pool of solvers that includes quantum annealers and hardware-based annealers. Embodiments of the invention further relate to reconfiguring the smaller QUBOs, prior to solving the smaller QUBOs, in order to reduce the number of smaller QUBOs orchestrated on quantum annealers.

Embodiments of the invention are discussed in the context of problems that are represented as QUBOs. However, embodiments are not limited thereto and may be applied to other problems and problem representations including Ising optimization models.

Embodiments of the invention are further discussed in the context of solvers that include quantum annealers and classical annealers. Quantum annealers are generally associated with real quantum hardware and classical annealers relate to classical computing systems (e.g., processor, memory, field programmable gate array (FPGA)). However, other types of annealers, such as hybrid annealers, may be included in the analysis.

Embodiments of the invention are further discussed in the context of optimization problems and the use of annealers to solve the optimization problems. However, embodiments of the invention are not limited to annealers and may be performed generally with respect to quantum computing and classical computing. Further, embodiments of the invention are not limited to optimization problems and may be used for other applications including machine learning operations (including training operations), probability sampling, finding global minimums in large search spaces, and the like.

Embodiments of the invention relate to solving a QUBO by decomposing or cutting the QUBO into smaller QUBOs. The smaller QUBOs are matched to and solved in suitable hardware (quantum or classical annealers) that is, in one example, compliant with any relevant service level objectives (SLOs). One advantage of decomposing QUBOs into smaller QUBOs is to facilitate an analysis of their heterogeneous structures. This allows each of the smaller QUBOs to be solved in more adequate hardware (e.g., classical annealer, quantum annealer, FPGA) or using another algorithm or heuristic that uses the same hardware with other algorithms, such as simulated annealing and simulated quantum annealing. Embodiments of the invention further relate to orchestrating the delivery of each smaller QUBO to the appropriate solver and algorithm.

Embodiments of the invention match the smaller QUBOs with the appropriate annealer, in one example, by determining the difficulty of the smaller QUBOs in advance. The smaller QUBOs are then reconfigured (e.g., by exchanging qubits) and their difficulty is reassessed. This allows, in some examples, the difficulty of a smaller QUBO to be reduced such that the smaller QUBO can be orchestrated to a classical annealer. When a set of QUBOs (the smaller QUBOs resulting from cutting an original QUBO) are run on a set of annealers executed on quantum or classical hardware, some of the smaller QUBOs are more suitable to attain the service level objectives on specific hardware according to their features. As a result, embodiments of the invention further relate to ranking the smaller QUBOs and dividing or orchestrating according to hardware suitability.

In one example, the availability of an annealer (i.e., a budget allocated for using the annealer) is constrained and one aspect of embodiments of the invention is to attain the service level objective informed by a user. In one example, models are trained using historical data to predict or provide an indicator of SLO attainability for a given QUBO in given hardware. The classifier may account for features or characteristics of the annealers as well. In other words, the model, which may be a classifier, may indicate with a particular QUBO is suitable for solving on a quantum annealer or a classical annealer.

To orchestrate the operation of assigning or delivering QUBOs (e.g., QUBO jobs, QUBO workloads) to a pool of annealers, embodiments of the invention may modify smaller QUBOs into equivalent smaller QUBOs that are suitable for classical annealers and quantum annealers in order to comply with the SLOs.

Embodiments of the invention can be viewed as a pipeline that is configured to solve complex and large QUBO problems in the context of quantum annealer availability and various constraints (e.g., service level objectives). In the pipeline, a QUBO problem Q is partitioned (decomposed, cut) into smaller QUBOs. The smaller QUBOs, which fit on available annealers, are scheduled and/or parallelized on a pool of classical and quantum annealers after being reconfigured as discussed herein. In one example, steps of the pipeline for solving the QUBO may be subject to the availability of the quantum annealers. In one example, the pipeline, which may include an orchestration engine, is configured to send the smaller QUBOs to classical annealers (e.g., simulated annealers or simulated quantum annealers) when possible.

In order to orchestrate the execution of the smaller QUBOs in annealers selected from a pool of annealers, as set of constraints (T) that defines the service level objectives may be determined or defined. The set of constraints T may provide stopping criteria for the pipeline. More specifically, aspects of the pipeline may include operations where the smaller QUBOs are reconfigured. When the stopping criteria is satisfied, the resulting QUBOs are orchestrated in the pool of annealers.

In some examples, the constraints may be soft constraints such that deviations from an SLO metric during execution may be allowed such that the annealers can complete the solving process rather that immediately halting the solving process. A hard constraint may be implemented by increasing a granularity in indicating time checkpoints to stop as soon as T is reached or close to being reached.

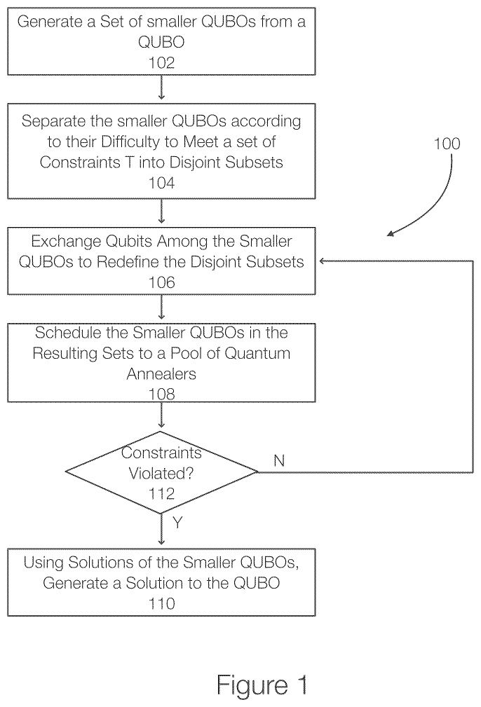

FIG. 1 discloses aspects of a method for orchestrating a process or pipeline of solving a QUBO. The method 100 is generally directed to solving a QUBO and may be performed by an orchestration engine implemented in a classical computing system. After receiving a QUBO into the pipeline, a set of smaller QUBOs is generated 102 by decomposing or cutting the original QUBO into the set of smaller QUBOs.

By way of example, a QUBO Q is separated into K groups with a minimum number of monomials among these groups in one example. The output of this process will be a portioned matrix as follows:

$$Q = ( \begin{matrix}{Q}_{1} & … & {Q}_{1 , N} \\ ⋮ & ⋱ & ⋮ \\ {Q}_{N , 1} & … & {Q}_{N}\end{matrix} ) .$$

These smaller QUBOS (QUBOs Q_{i,j}) correspond to problems to be solved in separate annealers. Every iteration of this algorithm runs K number of QUBO problems, and one set of values

$${x}_{k}^{l}$$

at iteration l generates a subproblem P_{k,l}. Thus, every k QUBO problem Qₖ at iteration l is:

$${p}_{k , l} : {min}_{{x}_{k}} {x}_{k}^{T} {Q}_{k} {x}_{k} + {\sum }_{j ∈ \{ 1 … K \} ∖ k} {x}_{k}^{T} {\hat{Q}}_{kj} {x}_{j}^{l - 1} .$$

In this example, Qₖ is the part of the QUBO matrix that only interacts variables on subset k, and Q_{k,j} is the part of the QUBO matrix that interacts variables of subset k and j. This heuristic allows a current solution x^{l} to be saved and permits the iterations to continue until stopped or until a local minimum (e.g., no progress in the value of the objective function due to a threshold) is achieved or due to a number of L iterations.

The smaller QUBOs are separated 104, according to the difficulty in meeting the set of constraints T, into two subset: QS_{QC} and QS_{CC}. The subset QS_{QC} includes the smaller QUBOs that are initially planned for quantum computing systems due to their difficulty and the subset QS_{CC} includes the smaller QUBOs that are initially planned for classical annealers. The smaller QUBOs are separated into these two subsets QS_{QC} and QS_{CC} using, by way of example only, an analytical procedure or a binary classifier trained on historical data. Thus, the smaller QUBOs are separated into these two sets using a classifier in one example.

The method 100 then processes the two subsets QS_{QC} and QS_{CC} by exchanging qubits among the smaller QUBOs in a manner that allows some of the problems in the subset QS_{QC} to be moved to the subset QS_{CC}. In some embodiments, the connectivity among the smaller QUBOs is considered. This allows more of the smaller QUBOs to be orchestrated to classical annealers.

Once the two subsets QS_{QC} and QS_{CC} are redefined by reconfiguring the smaller QUBOs, the smaller QUBOs of the subset QS_{CC} are scheduled to a pool of classical annealers while the smaller QUBOs of the subset QS_{QC} are scheduled to a pool of quantum annealers. In one example, the smaller QUBOs are scheduled on a first-come-first-serve basis or using another orchestration mechanism. The execution of the smaller QUBOs in the solvers may be parallelized.

Running the smaller QUBOs in the pool of annealers generates a result or solution for each of the smaller QUBOs. Using the solutions to the smaller QUBOs, a solution to the original QUBO is determined 110. More specifically, a composer is used to obtain a solution so for the QUBO Q.

In one example, composers form a class of algorithms that find the final solution for the original QUBO considering the solutions found after solving each decomposed QUBO (the smaller QUBOs). Notwithstanding, composers may also act as post-processing tools over the final solution of the original problem.

The method 100 may also include a loop after scheduling and running the smaller QUBOs. More specifically, if the constraints (e.g., SLOs) have not been violated (N at 112), the method returns to element 106 and the smaller QUBOs are reconfigured by exchanging qubits among the smaller QUBOs. If the constraints are violated (Y at 112), then the solution to the QUBO is determined 110.

The pipeline of the method 100 may include a classifier configured to predict or infer the difficulty of each of the smaller QUBOs. The smaller QUBOs that are classified as easier to solve are included in the set QS_{CC} while the smaller QUBOs that are classified as more difficult to solve are included in the set QS_{QC}. In effect, the smaller QUBOs are ranked and divided into the two sets of QUBOs.

During the method 100, the smaller QUBOs may be reconfigured. For example, a QUBO from each of the sets may be selected. These selected QUBOs are reconfigured by exchanging qubits in some manner. The reconfigured QUBOs are classified and placed back in the appropriate subset. Thus, the smaller QUBOs are separated (and reseparated) according to their ranking in attaining SLOs and their subsequent modifications by exchanging qubits. In one example, the modifications or reconfiguration of a QUBO is based on their connectivity and coefficients.

Embodiments of the invention further reduce the usage of quantum annealers when solving large QUBOs based on efficient cutting strategies, which include considering hardware properties of orchestration system and features of the annealers in a pool of annealers. Embodiments of the invention may use hardware telemetry to guide a cutting process and the subsequent analytical evaluation of the smaller QUBOs regarding their ranking of attaining SLOs. Decomposing or cutting a QUBO typically refers to processing operations to reduce the size of the QUBO or break the QUBO into smaller QUBOs. Smaller problems are a better fit for resource-constrained environments (e.g., real quantum annealers). An example heuristic to perform QUBO cutting is defined in Rosenberg et. al. See G. V. M. W. B. H. E. Rosenberg, “Building an iterative heuristic solver for a quantum annealer,” Computational Optimization and Applications, vol. 65, pp. 845-869, 2016, which is incorporated by reference in its entirety.

As discussed herein, embodiments of the invention may be configured to attain various service level objectives. The service level objectives may relate to time, cost, to minimizing the use of quantum annealers, or the like or combinations thereof. When the service level objective is to minimize the use of quantum annealers, embodiments may determine the hardness or difficulty in solving the QUBO (smaller QUBO). In order to orchestrate more smaller QUBOs on classical annealers, embodiments of the invention may process the smaller QUBOs, for example by exchanging qubits. Exchanging qubits may change the difficulty level of the smaller QUBO and may allow more of the smaller QUBOs to be orchestrated on classical annealers in classical hardware.

Embodiments of the invention may explore properties of the QUBO problems to attain service level objectives as well as modify some of the smaller QUBOs to make them attain a service level objective using a quantum annealer or a classical annealer by exchanging qubits.

For example, a pair of smaller QUBOs can be represented by their hardness level to attain service level objectives using classical computers. The levels may include level-1-hard, level-2-hard and level-3-hard. In this example, the number indicates the hardness level, starting at 1 (i.e., level-1-hard is an easy problem). Using this schema, classical annealers may be used to solve easier QUBOs while quantum annealers are used to solve harder subproblems (e.g., level-2 and level-3-hard).

Quantum annealers are expensive and have overheads associated with waiting queues and loading times, solving the minor-embedding problem, and the like. However, the input of a harder problem does not necessarily imply more processing time for quantum annealers compared to easier problems.

In one example, embodiments of the invention may assume a complex QUBO Q that is sufficiently large and cannot be embedded on a quantum annealer. As a result, it is necessary to partition the original QUBO into smaller QUBOs, which can be solved on available solvers. Further, the use of one or multiple quantum annealers are subject to service level objectives, which are referred to as a set of constraints T. In one example, it is assumed that running on a classical computer system is not time-bounded. It is also assumed that the classical computing infrastructure has sufficient resources (e.g., RAM, storage) for any smaller QUBOs generated from the original QUBO Q.

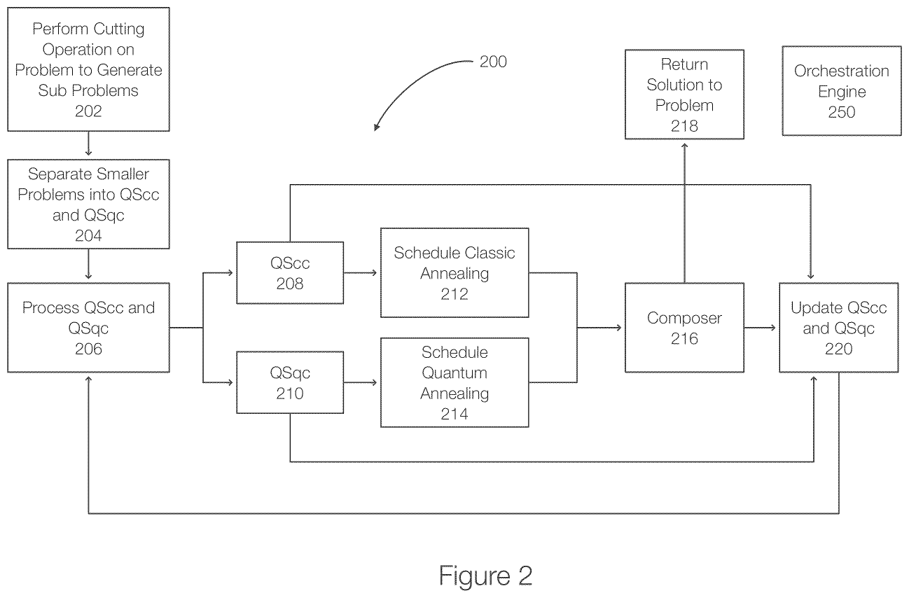

FIG. 2 discloses aspects of solving problem such as a QUBO. The method 200 may be performed by an orchestration engine 250, which may be implemented in classical computing systems. In one example, a problem is received and cutting or decomposition is performed 202 to generate subproblems. More specifically, a QUBO cutting algorithm is applied to Q to generate a set of smaller QUBOs QS.

The subproblems are separated 204 according to their feasibility to attain T (the set of constraints) in a quantum annealer or a classical annealer. The subproblems are separated into subsets QS_{QC} and QS_{CC}. In one example, the subproblems are separated 204 by a binary classifier trained on labelled historical data to generate an output or inference. The data or historical data used to train the classifier may include, in one example, QUBO size in relation to number of qubits, QUBO density and/or a flag indicating whether the main diagonal is non-negative. Other data that may be relevant to determining the difficulty or that is indicative of the difficulty may also be included. The output or inference of the classifier indicates whether a particular subproblem is best suited for solving on a classical annealer or quantum annealer. Once the subproblems are initially separated into the subsets QS_{QC} and QS_{CC}, the subsets QS_{QC} and QS_{CC} are processed 206.

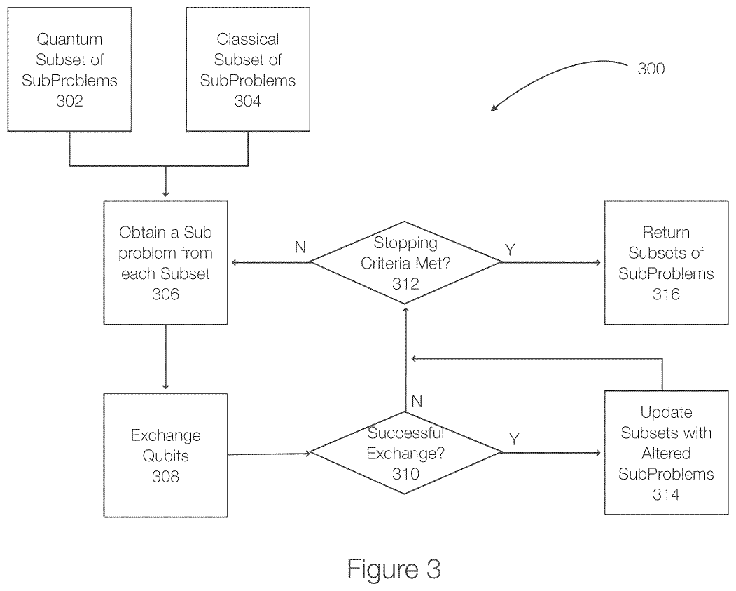

FIG. 3 discloses aspects of processing 206 the two subsets of subproblems QS_{QC} and QS_{CC} indicated in 206. FIG. 3 illustrates a method 300 that processes a subset or set 302 of subproblems QS_{QC} and a subset or set of subproblems QS_{CC} 304. The method 300 includes obtaining 306 a subproblem from the subset 302 and a subproblem from the subset 304. For a selected pair of smaller QUBOs q_{QC}∈QS_{QC} and q_{CC}∈QS_{CC}, two new smaller QUBOs are generated by exchanging 308 qubits with respect to q_{QC} and q_{CC}.

By exchanging qubits, embodiments are configured to attain T of q_{QC} by passing a qubit from q_{QC} to q_{CC} and/or vice-versa. Qubits may be exchanged in other manners. For example, qubits may be moved from one of the subproblem to the other subproblem. Alternatively, qubits may be exchanged between the two subproblems. This generates a new pair of smaller QUBOs q_{QC′} and q_{CC′}. The exchange is considered successful when q_{QC′} and q_{CC′} are classified using the classifier to be used on quantum annealers or classical and attain T.

When the exchange is successful (Y at 310), this may trigger a removal of q_{QC} and q_{CC} from their original subsets 302 and 304 and the inclusion of q_{QC′} and q_{CC′} into QS_{CC} or QS_{QC} according to their new classification. Eventually, it may not be possible to attain T by exchanging qubits (N at 310). In this case, q_{QC} remains in QS_{QC} or q_{CC} in QS_{CC}.

Next, if the stopping criteria is satisfied (Y at 312), the subsets 302 and 304 as now constituted are returned 316. If the stopping criteria is not met (N at 312), the subsets 302 and 304 are further processed in the method 300 and another pair of subproblems are obtained 306.

In one example, if may not be useful or possible to analyze if the exchange maximize the likelihood of attaining T (if constraints of T have a ranking for their feasibilities, i.e., a residual distance from its target).

More specifically, exchanging 308 qubits may be performed as follows. A qubit qₑ from q_{QC} is obtained or selected that that has a minimum negative coefficient on the diagonal of q_{QC}'s QUBO matrix. If a similar value exists for more than one qubit, the qubit with less connectivity with other qubits and more connectivity with qₑ is selected. In this context, the connectivity stands for a pair of qubits with non-zero coefficient in a QUBO matrix. The minimum negative coefficient on the diagonal is used as an indicator of hardness to attain the service level objectives (e.g., the service level objectives are to solve QUBOs faster or use fewer quantum annealers). Removing this element or qubit can reduce the hardness of q_{QC} and may make q_{QC} suitable to be solved by classical computing, thereby attaining the service level objective of using fewer quantum annealers.

The qubit from q_{QC} is put on q_{CC}, which becomes q_{CC′}. The signal of the diagonal is tested with the new qubit on q_{e′}. If q_{e′} is easy, the qubit remains in q_{CC′} and the qubit is removed from q_{QC}, which becomes q_{QC′}. Thus, the exchange 308 is successful.

Next, q_{CC′} is placed into QS_{CC} and q_{QC′} is placed into QS_{QC}. Also, q_{QC} is removed from QS_{QC} and q_{CC} is removed from QS_{CC} as illustrated at 220. In one example, this process is repeated form every pair of smaller QUBOs with negative diagonal qubits on the smaller QUBOs included in of QS_{QC}.

In one example, the number of iterations may depend on all combinations of pairs of relevant smaller QUBOs in QS_{CC} and QS_{QC}. In some example, this number can be large enough to make the loop computationally infeasible. As manner of reducing the number of iteration steps, various strategies may be used, such as a random sampling of smaller QUBOs, ranking and selecting smaller QUBOs based on their difficulties, maximum number of iterations, and so on.

Returning to FIG. 2, once QS_{CC} and QS_{QC} are redefined and returned 316 in the method 300, the subproblems of the now redefined sets 302 and 304 (QS_{CC} and QS_{QC}) are solved, respectively, using a pool of classical annealers 212 and a pool of quantum annealers 214. Each pool of annealers can be represented by one or multiple annealers, and scheduling each smaller QUBO to a solver can be done using a queueing system (or orchestration system), including when the number of smaller QUBOs is larger than the number of annealers in the pool.

An orchestration system, which may be an external system, for controlling the usage of quantum annealers under the limitation of T (set of SLOs constraints) may be used.

Once the subproblems have been solved on the classical annealers and the quantum annealers, the composer 216 analyzes the solutions to the subproblems to obtain a solution so for the original QUBO Q. If the constrains are not violated, the two subsets of problems are processed iterative (e.g., see 206, 208, 210, 220 and the method 300). Once the constraints are violated or for other reasons (e.g., convergence is achieved), a solution is returned 218. More specifically, the best s_{Q} found among all iterations is returned as a solution for Q. In one example, there will be at least one solution s_{Q} to the QUBO Q once all smaller QUBOs of QS_{CC} and QS_{QC} are solved. This may assume, however, that a solution can be determined in the first iteration. If a solution cannot be determined in the first iteration, the set of constraints T is underestimated.

Generally, the method 200 solves a QUBO Q by decomposing the QUBO Q into smaller QUBOs, which are divided into smaller QUBOs based on their difficulty. While easy smaller QUBOs are solved in classical computers (e.g., simulated annealing), the hard smaller QUBOs are solved on quantum annealers as a way of leveraging quantum effects to achieve good solutions. This iterative process, however, is subjected to a budget of usage in quantum annealing (e.g., time units). At each iteration, a new solution for Q is obtained and the sets of easy and hard smaller QUBOs are redefined, permitting a broad exploration of the search space of solutions. At the end of these operations, the best solution so for Q is returned.

### EXAMPLE

The following example assumes that the set of constraints T includes a single constraint budget of solving at most n QUBOs in the pool of quantum annealers and classical computers, by minimizing the usage of quantum annealers.

In this example, Q is an input QUBO problem and QS={q₀, q₁, q₂, q₃}. QS is the subset of smaller QUBOs after applying a cutting or decomposing algorithm.

Next, QS is partitioned into QS_{CC}={q₀, q₁} and QS_{QC}={q₂, q₃} using a binary classifier machine learning model that predicts if a given qᵢ is easy to be solved (take less time) on a quantum computer or classical computer.

In this example, interchanging or exchanging qubits between the smaller QUBOs in QS_{CC} and QS_{QC} results in QS_{CC}={q′₀, q₁, q′₂} and QS_{QC}={q₃}, where q′₀ and q′₂ are new smaller QUBOs generated from the interchanging of qubits of original smaller QUBOs q₀ and q₂. These exchanges make q′₀ and q′₂ easy to be solved in classical computing and these reconfigured QUBOs are included in QS_{CC}.

The smaller QUBOs in these subsets QS_{CC} and QS_{QC} are then distributed into the appropriate hardware. More specifically, QS_{CC} is orchestrated to the pool of classical annealers while QS_{QC} is orchestrated to the pool of quantum annealers.

Next, the solutions obtained by these solvers are combined into a solution equivalent to Q, or s_{Q}.

If the budget determined in T allows the re-execution of the whole pipeline, the pipeline can be conducted again in order to generate another s_{Q} that could be potentially better than the best s_{Q} obtained in previous iterations of the pipeline.

Otherwise, the solution is returned. More specifically, once the budget of solving in quantum annealers is fully used, the algorithm returns the best s_{Q} to the user and the operations halt.

When exchanging qubits, one goal is to decrease the number of smaller QUBOs in QS_{QC} by reducing the hardness of some of its problems and moving them to QS_{CC}. After reconfiguring the smaller QUBOs and redefining the two sets QS_{QC} and QS_{CC}, the problems remaining in QS_{QC} are determined to be hard for classical annealers and are suitable for solving on quantum annealers.

In one example, the stopping criteria related to updating QS_{CC} and QS_{QC} could be, for example, achieving a minimum number of problems moved from QS_{QC} and QS_{CC} or a time budget also declared as constraint in T.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, machine learning related operations, classifier operations, cutting operations, composing operations, problem reconfiguration (e.g., interchanging or exchanging qubits) operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: decomposing a problem into subproblems, separating the subproblems into a first set of subproblems for execution in a pool of classical annealers and a second set of subproblems for execution in a pool of quantum annealers, updating the first set of subproblems and the second set of subproblems by exchanging qubits between a first subproblem from the first set and a second subproblem from the second set to generate a new first subproblem and a new second subproblem, determining whether the exchanging qubits was successful, moving the new first subproblem and the new second subproblem to the first set of subproblems and removing the first subproblem from the first set of subproblems and removing the second problem from the second set of subproblems such that the first set of subproblems and the second set of subproblems are redefined, orchestrating the first set of subproblems to the pool of classical annealers and orchestrating the second set of subproblems to the pool of quantum annealers, and generating a solution to the problem from solutions of the subproblems.

Embodiment 2. The method of embodiment 1, further comprising repeating one or more aspects of embodiment 1 until a set of constraints is violated or close to being violated.

Embodiment 3. The method of embodiment 1 and/or 2, further comprising returning a best solution from a set of solutions for the subproblems.

Embodiment 4. The method of embodiment 1, 2, and/or 3, further comprising separating the subproblems by classifying each of the problems in a binary classifier, wherein subproblems classified as easy are placed in the first set of subproblems and subproblems classified as harder are placed in the second set of subproblems.

Embodiment 5. The method of embodiment 1, 2, 3, and/or 4, wherein exchanging qubits includes obtaining a qubit from the second subproblem that has a minimum negative coefficient on a diagonal of a matrix of the second subproblem and adding the qubit to the first subproblem.

Embodiment 6. The method of embodiment 1, 2, 3, 4, and/or 5, wherein the qubit has a lowest connectivity with other qubits in the second subproblem.

Embodiment 7. The method of embodiment 1, 2, 3, 4, 5, and/or 6, further comprising reconfiguring multiple first subproblems from the first set of subproblems and multiple second problems from the second set of subproblems in pairs by exchanging qubits to move at least some of the subproblems in the second set of subproblems to the first set of subproblems.

Embodiment 8. The method of embodiment 1, 2, 3, 4, 5, 6, and/or 7, wherein the problem is a QUBO and the subproblems are QUBOs cut from the QUBO.

Embodiment 9. The method of embodiment 1, 2, 3, 4, 5, 6, 7, and/or 8, further comprising determining a set of constraints, wherein the set of constraints includes one or more of a time budget, a number of executions on the quantum annealers, a number of subproblems moved from the first set to the second set, or combinations thereof.

Embodiment 10. The method of embodiment 1, 2, 3, 4, 5, 6, 7, 8, and/or 9, wherein stopping criteria for stopping updating of the first set of subproblems and the second set of subproblems includes achieving the number of subproblems moved from the first set to the second set, meeting a time budget, or meeting a usage of the quantum annealers.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

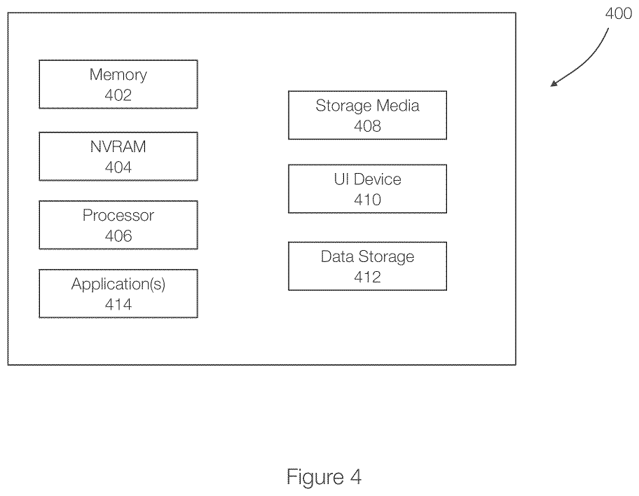

With reference briefly now to FIG. 4, any one or more of the entities disclosed, or implied, by the Figures and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

The device 400 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 400 may also represent a physical or virtual machine or server, an edge-based computing system, a cloud-based computing system, server clusters or other computing systems or environments. The device 400 may also represent multiple machines or devices, whether virtual, containerized, or physical. The device 400 may perform or execute steps or acts of the methods illustrated in the Figures. The device 400 may also represent a client-server computing environment, which may be present in networks including the Internet. The device 400 may also represent a classical computing environment suitable for emulating a classical annealer.

The described embodiments are to be considered in all respects only as illustrative and not restrictive. All changes which come within the meaning and range of equivalency of the claims are to be embraced within their scope.

What is claimed is:

1. A method comprising:
(a) decomposing a problem into subproblems;
(b) separating the subproblems into a first set of subproblems for execution in a pool of classical annealers and a second set of subproblems for execution in a pool of quantum annealers;
(c) updating the first set of subproblems and the second set of subproblems by exchanging qubits between a first subproblem from the first set and a second subproblem from the second set to generate a new first subproblem and a new second subproblem;
(d) determining whether the exchanging qubits was successful;
(e) moving the new first subproblem and the new second subproblem to the first set of subproblems and removing the first subproblem from the first set of subproblems and removing the second problem from the second set of subproblems such that the first set of subproblems and the second set of subproblems are redefined;
(f) orchestrating the first set of subproblems to the pool of classical annealers and orchestrating the second set of subproblems to the pool of quantum annealers; and
(g) generating a solution to the problem from solutions of the subproblems.

2. The method of claim 1, further comprising performing (c), (d), (e) and/or (f) until a set of constraints is violated or close to being violated.

3. The method of claim 2, further comprising returning a best solution from a set of solutions for the subproblems.

4. The method of claim 1, further comprising separating the subproblems by classifying each of the problems in a binary classifier, wherein subproblems classified as easy are placed in the first set of subproblems and subproblems classified as harder are placed in the second set of subproblems.

5. The method of claim 1, wherein exchanging qubits includes obtaining a qubit from the second subproblem that has a minimum negative coefficient on a diagonal of a matrix of the second subproblem and adding the qubit to the first subproblem.

6. The method of claim 5, wherein the qubit has a lowest connectivity with other qubits in the second subproblem.

7. The method of claim 1, further comprising reconfiguring multiple first subproblems from the first set of subproblems and multiple second problems from the second set of subproblems in pairs by exchanging qubits to move at least some of the subproblems in the second set of subproblems to the first set of subproblems.

8. The method of claim 1, wherein the problem is a QUBO and the subproblems are QUBOs cut from the QUBO.

9. The method of claim 1, further comprising determining a set of constraints, wherein the set of constraints includes one or more of a time budget, a number of executions on the quantum annealers, a number of subproblems moved from the first set to the second set, or combinations thereof.

10. The method of claim 9, wherein stopping criteria for stopping updating of the first set of subproblems and the second set of subproblems includes achieving the number of subproblems moved from the first set to the second set, meeting a time budget, or meeting a usage of the quantum annealers.

11. A non-transitory storage medium having stored therein instructions that are executable by one or more hardware processors to perform operations comprising:
(a) decomposing a problem into subproblems;
(b) separating the subproblems into a first set of subproblems for execution in a pool of classical annealers and a second set of subproblems for execution in a pool of quantum annealers;
(c) updating the first set of subproblems and the second set of subproblems by exchanging qubits between a first subproblem from the first set and a second subproblem from the second set to generate a new first subproblem and a new second subproblem;
(d) determining whether the exchanging qubits was successful;
(e) moving the new first subproblem and the new second subproblem to the first set of subproblems and removing the first subproblem from the first set of subproblems and removing the second problem from the second set of subproblems such that the first set of subproblems and the second set of subproblems are redefined;
(f) orchestrating the first set of subproblems to the pool of classical annealers and orchestrating the second set of subproblems to the pool of quantum annealers; and
(g) generating a solution to the problem from solutions of the subproblems.

12. The non-transitory storage medium of claim 11, further comprising performing (c), (d), (e) and/or (f) until a set of constraints are violated or close to being violated.

13. The non-transitory storage medium of claim 12, further comprising returning a best solution from a set of solutions for the subproblems.

14. The non-transitory storage medium of claim 11, further comprising separating the subproblems by classifying each of the problems in a binary classifier, wherein subproblems classified as easy are placed in the first set of subproblems and subproblems classified as harder are placed in the second set of subproblems.

15. The non-transitory storage medium of claim 11, wherein exchanging qubits includes obtaining a qubit from the second subproblem that has a minimum negative coefficient on a diagonal of a matrix of the second subproblem and adding the qubit to the first subproblem.

16. The non-transitory storage medium of claim 15, wherein the qubit has a lowest connectivity with other qubits in the second subproblem.

17. The non-transitory storage medium of claim 11, further comprising reconfiguring multiple first subproblems from the first set of subproblems and multiple second problems from the second set of subproblems in pairs by exchanging qubits to move at least some of the subproblems in the second set of subproblems to the first set of subproblems.

18. The non-transitory storage medium of claim 11, wherein the problem is a QUBO and the subproblems are QUBOs cut from the QUBO.

19. The non-transitory storage medium of claim 11, further comprising determining a set of constraints, wherein the set of constraints includes one or more of a time budget, a number of executions on the quantum annealers, a number of subproblems moved from the first set to the second set, or combinations thereof.

20. The non-transitory storage medium of claim 19, wherein stopping criteria for stopping updating of the first set of subproblems and the second set of subproblems includes achieving the number of subproblems moved from the first set to the second set, meeting a time budget, or meeting a usage of the quantum annealers.
